(19) United States
(12) Patent Application Publication
(10) Pub. No.: US 2026/0270554 A1
(43) Pub. Date: Sep. 10, 2026

(54) IMAGE CAPTURE APPARATUS AND CONTROL METHOD

(71) Applicant: CANON KABUSHIKI KAISHA, Tokyo (JP)

(72) Inventors: NOBUYUKI HORIE, Tokyo (JP); RYO ISHIKAWA, Kanagawa (JP)

(21) Appl. No.: 19/553,643

(22) Filed: Mar. 2, 2026

(30) Foreign Application Priority Data
Mar. 6, 2025 (JP) 2025-035856

(51) Int. Cl. H04N 23/60; G06F 3/16; H04N 23/611; H04N 23/667; H04N 23/63

(52) U.S. Cl. CPC H04N 23/64; G06F 3/162; G06F 3/167; H04N 23/611; H04N 23/667; H04N 23/632

(57) ABSTRACT

An image capture apparatus which captures an image and stores the image as a recorded image, acquires audio information at the time of shooting the recorded image, generates a caption of the recorded image based on the recorded image and the audio information, and controls the audio information to be output to the caption generation unit.

### BACKGROUND

### Field of the Technology

The present disclosure relates to a technical field of generating a caption of an image by generative AI.

### Description of the Related Art

Generation of a caption (subtitles and explanation) of an image by generative Artificial Intelligence (AI) is a useful technique when viewing an image without any sound or searching for an image by text.

Japanese Patent Laid-Open No. 2020-13427 describes a method of improving caption generation accuracy by extracting a whole feature and partial features from an image, specifying a region of interest from these features, and weighting the region of interest.

When a caption is generated only by an image as described in Japanese Patent Laid-Open No. 2020-13427, it may be impossible to accurately generate a caption depending on a scene of an image.

### SUMMARY

The present disclosure has been made in consideration of the aforementioned problems, and provides technical advantages in improving caption generation accuracy, as compared with a case where a caption is generated only by an image.

In order to solve the aforementioned problems, the present disclosure is directed to an image capture apparatus which captures an image and stores the image as a recorded image, comprising: an audio acquisition unit that acquires audio information at the time of shooting the recorded image; a caption generation unit that generates a caption of the recorded image based on the recorded image and the audio information; and a control unit that controls the audio information to be output to the caption generation unit.

According to the present disclosure, it is possible to improve caption generation accuracy, as compared with a case where a caption is generated only by an image.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram exemplifying the hardware configuration of an image capture apparatus according to a first embodiment.

FIG. 2 is a block diagram exemplifying the functional configuration of the image capture apparatus according to the first embodiment.

FIG. 3 is a view illustrating a caption generation method according to the first embodiment.

FIG. 4 is a flowchart exemplifying caption generation processing according to the first embodiment.

FIG. 5 is a block diagram exemplifying the functional configuration of an image capture apparatus according to a second embodiment.

FIG. 6 is a view illustrating a caption generation method according to the second embodiment.

FIG. 7 is a flowchart exemplifying caption generation processing according to the second embodiment.

FIG. 8 is a view exemplifying a lookup table for sound determination according to a third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

This embodiment will describe an example in which when an image capture apparatus such as a digital camera generates a caption of an image based on an image recorded in accordance with a shooting instruction and audio information for a period of a predetermined number of frames before and after the recorded image is shot, the caption is accurately generated even in a case where a status cannot be determined based on one image.

Note that the image capture apparatus according to this embodiment may be, for example, a smartphone, a tablet computer (PC), or the like having a camera function.

### First Embodiment

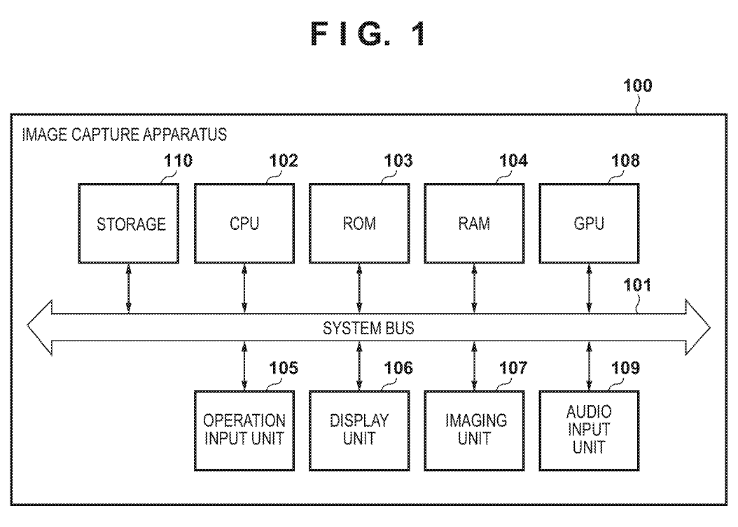

A first embodiment will be described with reference to FIGS. 1 to 4.

### Apparatus Configuration

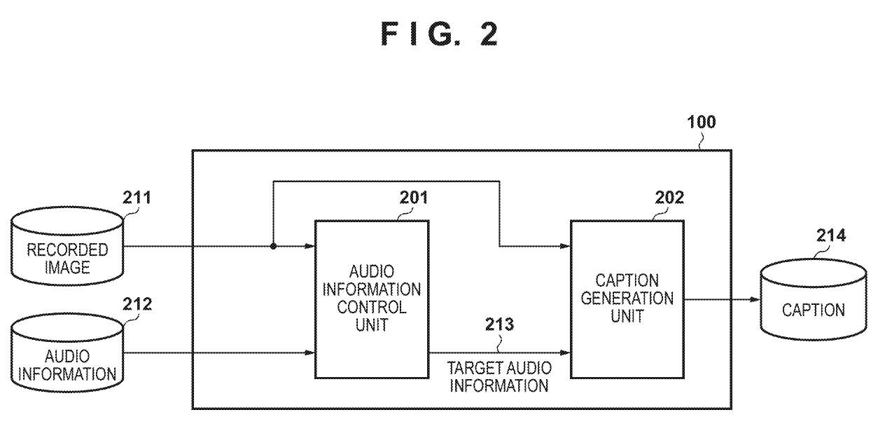

The configuration and function of an image capture apparatus 100 according to this embodiment will be described with reference to FIGS. 1 and 2.

The image capture apparatus 100 includes a CPU 102, a ROM 103, a RAM 104, an operation input unit 105, a display unit 106, an imaging unit 107, a GPU 108, an audio input unit109, and a storage 110. The components of the image capture apparatus 100 are connected to be able to transmit/receive data via a system bus 101.

The CPU 102 is a control unit that controls the operation of the image capture apparatus 100. The CPU 102 executes a program stored in the ROM 103, and controls each component of the image capture apparatus 100 in accordance with an operation instruction received from the operation input unit 105.

The ROM 103 is a nonvolatile memory and stores a program for controlling the image capture apparatus 100. When the power of the image capture apparatus 100 is turned on, the CPU 102 loads the program from the ROM 103 and starts to control the image capture apparatus 100. The ROM 103 is, for example, a nonvolatile memory such as a flash memory.

The RAM 104 is a rewritable memory and is used as a work area by a program that controls the image capture apparatus 100. The RAM 104 is used as a buffer memory that temporarily holds image data captured by the imaging unit 107 and as an image display memory for the display unit 106. As the RAM 104, for example, a volatile memory (DRAM) using a semiconductor element is used.

The operation input unit 105 is formed from operation members such as various switches, buttons, and dials for accepting user operations. The operation input unit 105 includes, for example, a power button for turning on or off the power, a shutter button used to make an image shooting instruction, a reproduction button used to make an image reproduction instruction, and a mode switching button used to change the operation mode of the camera. The operation input unit 105 includes a touch panel integrally formed with the display unit 106.

While the shutter button is operated, that is, when the shutter button is pressed halfway (shooting preparation instruction), it is turned on to generate a first shutter switch signal SW1. Upon receiving the first shutter switch signal SW1, the CPU 102 starts a shooting preparation operation such as auto focus processing (AF) and auto exposure processing (AE) by controlling the imaging unit 107 (shooting preparation state). When the operation of the shutter button is completed, that is, the shutter button is pressed fully (shooting instruction), the shutter button is turned on to generate a second shutter switch signal SW2. Upon receiving the second shutter switch signal SW2, the CPU 102 starts a series of shooting operations from reading out image data from the imaging unit 107 to writing an image file in the storage 110 (shooting state).

The display unit 106 displays a live view image, a shot image, a Graphical User Interface (GUI) for an interactive operation, and the like. The display unit 106 is, for example, a display device such as a liquid crystal display or an organic EL display. The display unit 106 may be integrated with the image capture apparatus 100 or may be an external apparatus connected to the image capture apparatus 100. The image capture apparatus 100 need only be connectable to the display unit 106 and control display of the display unit 106.

The imaging unit 107 includes a lens group including a zoom lens and a focus lens, and a shutter having an aperture function. The imaging unit 107 includes an image sensor formed by a CCD or CMOS element that converts a subject image into an electrical signal, and an A/D converter that converts an analog image signal output from the image sensor into a digital signal. Under the control of the CPU 102, the imaging unit 107 converts subject image light whose image is formed by the lens included in the imaging unit 107 into an electrical signal by the image sensor, performs noise reduction processing or the like, and outputs image data formed from a digital signal.

The CPU 102 performs resize processing such as pixel interpolation and reduction or color conversion processing for the image data captured by the imaging unit 107. Furthermore, the CPU 102 performs compression coding using the JPEG format or the like for still image data having undergone image processing, or encodes moving image data by a moving image compression method such as MPEG2 or H.264, thereby generating an image file and recording it in the storage 110. In addition, the CPU 102 performs predetermined arithmetic processing using captured image data, and controls the focus lens, the aperture, and the shutter of the imaging unit 107 based on the obtained arithmetic result, thereby performing AF processing or AE processing.

The Graphics Processing Unit (GPU) 108 is a processor that performs parallel arithmetic processing of data. The GPU 108 can perform efficient arithmetic processing by performing parallel processing of more data and hence is effective in a case where learning processing is performed a plurality of times by using an Artificial Intelligence (AI) model such as a neural network, or a case where many product-sum operations are performed in inference processing, thereby making it possible to perform processing within a shorter time than the CPU 102. An equivalent function may be implemented by a reconfigurable logic circuit called an FPGA, instead of the GPU 108. Note that image processing executed by the CPU 102 may be executed by the GPU 108.

The audio input unit109 includes one or a plurality of microphones incorporated in the image capture apparatus 100 or connected to the image capture apparatus 100 via an audio terminal, and converts an analog audio signal, which is generated by picking up sound around the image capture apparatus 100, into a digital signal and outputs the digital signal to the CPU 102. The CPU 102 performs various kinds of audio signal processing on the digital signal generated by the audio input unit109, thereby generating audio data. When a moving image is shot, the CPU 102 generates a moving image file with audio from audio data generated by the audio input unit109 and image data generated by the imaging unit 107. When a still image is shot, the CPU 102 records only an image file without adding audio data generated by the audio input unit109 to image data generated by the imaging unit 107. Furthermore, when a still image is shot, the CPU 102 stores, in the RAM 104, audio data for a period of a predetermined number of frames before and after the recorded image is shot.

The storage 110 is a recording medium that stores an image file generated by the CPU 102, an AI model used for caption generation processing of this embodiment, and the like. Note that in this embodiment, the image file and the AI model are stored in the storage 110, but the present disclosure is not limited to this, and they may be input from an external apparatus on a network via a communication interface (not shown). The storage 110 is, for example, a hard disk drive (HDD) using a magnetic storage scheme or a solid-state drive (SSD) using a semiconductor element.

The following description assumes that an image added with no audio data, which has been shot by the image capture apparatus 100 of this embodiment, is a recorded image, and audio data for a period of a predetermined number of frames before and after the recorded image is shot is audio information.

FIG. 2 is a block diagram exemplifying the functional configuration of the image capture apparatus according to the first embodiment.

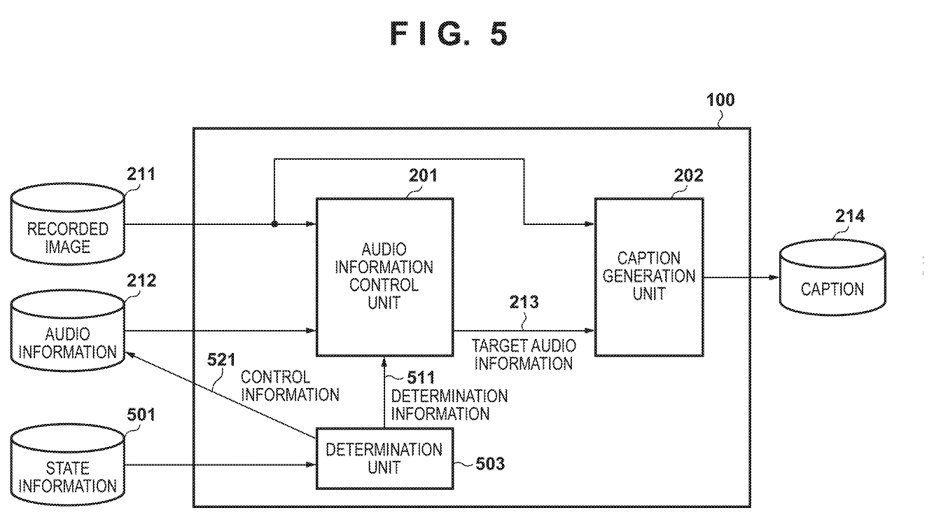

The function of the image capture apparatus 100 according to this embodiment is implemented by hardware shown in FIG. 1 and/or a software program executed by the CPU 102 and/or the GPU 108. The same applies to FIG. 5 to be described later.

The image capture apparatus 100 includes an audio information control unit 201 and a caption generation unit 202.

Upon receiving a shooting instruction from the operation input unit 105, the CPU 102 outputs a shot recorded image 211 to the audio information control unit 201 and the caption generation unit 202. The audio information control unit 201 acquires the recorded image 211 from the CPU 102. The audio information control unit 201 acquires audio information 212 at the time of shooting the recorded image 211 from the audio input unit109, and outputs, to the caption generation unit 202, target audio information 213 that has been selected from the audio information 212 based on the shooting timing of the recorded image 211.

The target audio information 213 may be, for example, audio information for a period of a predetermined number of frames before and after the recorded image 211 is shot, or audio information obtained by performing filter processing on the audio information 212 by the audio information control unit 201. In this embodiment, the filter processing is not particularly limited to a bandpass filter or a wind noise filter. This embodiment assumes that the processing of the audio information control unit 201 is rule-based audio signal processing, but processing using an AI model for acquiring necessary audio information may be performed.

The caption generation unit 202 performs inference processing using an AI model by receiving the recorded image 211 and the target audio information 213 as inputs, and generates a caption (subtitles and explanation) 214 for explaining an event, the behavior of a person/animal, and the like in the recorded image 211. For example, the caption generation unit 202 recognizes each element in the recorded image by an image recognition model, and generates a caption using a language model based on an image feature amount or an identified label.

In this embodiment, an AI model for caption generation is formed by a neural network, and the inference processing of this embodiment can be executed by the GPU 108. The GPU 108 is a processor capable of performing an enormous amount of product-sum operations, bias addition operations, and nonlinear processing, and has arithmetic processing capability of performing a matrix operation of a neural network and the like within a short time. Note that in the inference processing, the CPU 102 and the GPU 108 may perform arithmetic processing in cooperation with each other or one of the CPU 102 and the GPU 108 may perform arithmetic processing.

In this embodiment, a caption is generated using an AI model. However, rule-based processing using a lookup table (LUT) or the like may be performed.

In this embodiment, the image capture apparatus 100 inputs the recorded image 211 and the target audio information 213 to the caption generation unit 202, and generates a caption of the recorded image 211.

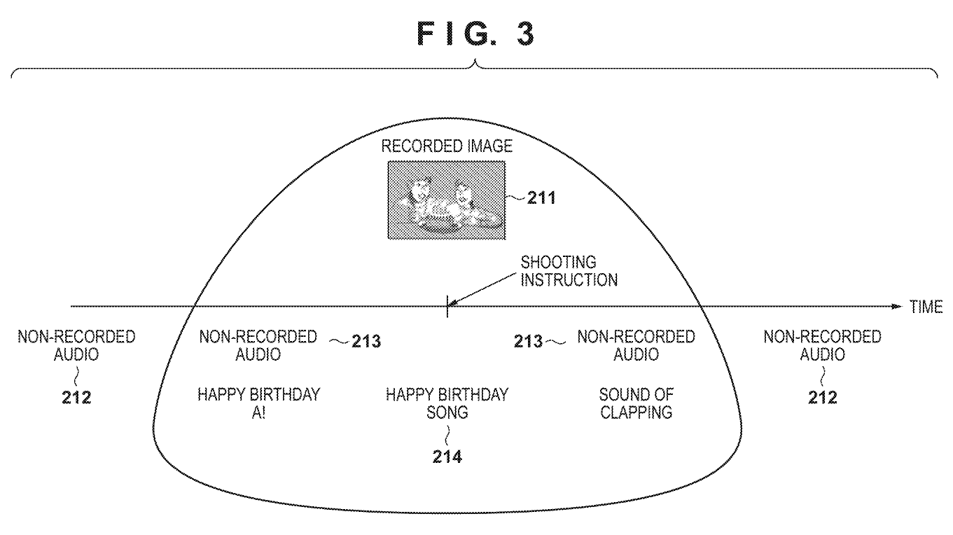

FIG. 3 exemplifies the recorded image 211, the audio information 212, the target audio information 213, and the caption 214 in the caption generation processing according to the first embodiment.

In this embodiment, when the image capture apparatus 100 is in an image shooting mode, the audio information 212 is always output from the audio input unit109, and is stored, as non-recorded audio that is not stored in the storage 110, in the RAM 104 for a predetermined period. In this embodiment, the non-recorded audio includes audio information for a period of a predetermined number of frames before and after the recorded image is shot.

In the example shown in FIG. 3, time elapses from left to right in FIG. 3, and the image capture apparatus 100 shoots and records one image in accordance with a shooting instruction from the user.

In conventional caption generation, a caption is generated using one recorded image. However, in the recorded image 211 shown in FIG. 3, it cannot be determined which of two subjects is celebrated and what they celebrate, and it is thus impossible to accurately generate a caption. To the contrary, in this embodiment, a caption is generated using non-recorded audio before and after the recorded image 211, such as a voice "happy birthday A!", a singing voice "happy birthday", or "sound of clapping" as shown in FIG. 3, in addition to the recorded image 211. Therefore, in this embodiment, an accurate caption of "It is A's birthday and they sing "happy birthday" to celebrate" that cannot be determined by one recorded image can be generated.

### Control Processing

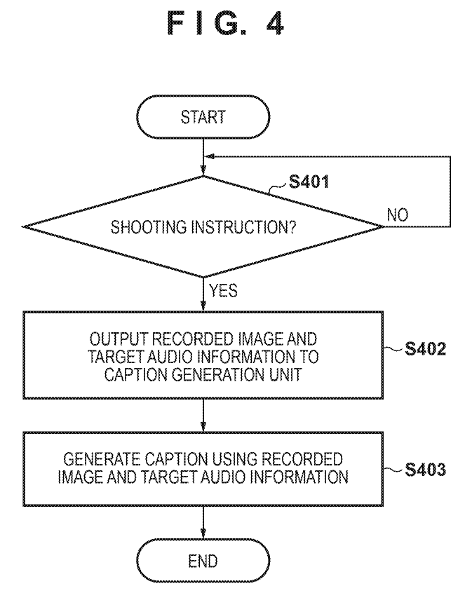

FIG. 4 is a flowchart exemplifying the caption generation processing according to the first embodiment.

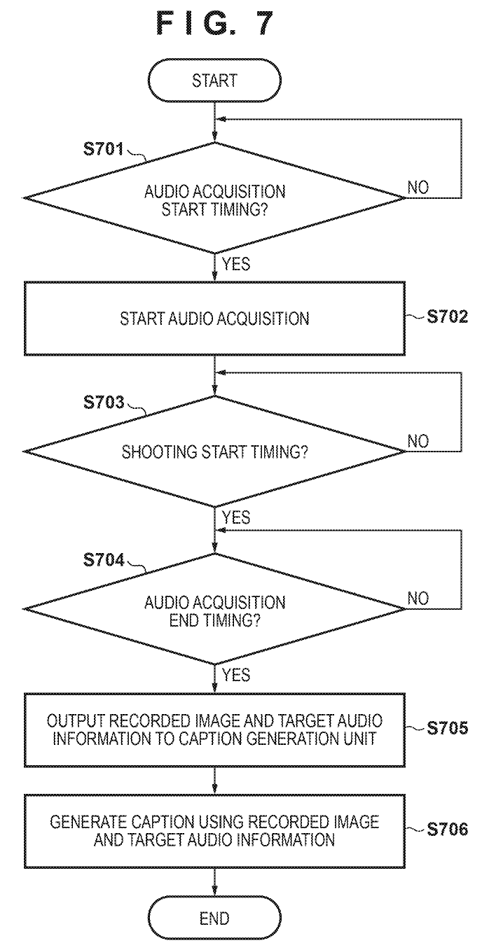

The processing shown in FIG. 4 is implemented by hardware shown in FIG. 1 and a software program executed by the CPU 102 and/or the GPU 108 for implementing the function shown in FIG. 2. The same applies to FIG. 7 to be described later.

In step S401, the CPU 102 determines whether a shooting instruction is received from the operation input unit 105. When it is determined that the shooting instruction is received, the process advances to step S402. When it is determined that no shooting instruction is received, the processing is continued.

In step S402, the CPU 102 outputs, to the audio information control unit 201 and the caption generation unit 202, the recorded image 211 that has been shot in response to the reception of the shooting instruction. The audio information control unit 201 acquires the audio information 212 from the audio input unit109, and outputs the target audio information 213 to the caption generation unit 202 based on the shooting timing of the recorded image 211. The caption generation unit 202 inputs the target audio information 213 output from the audio information control unit 201.

In step S403, the caption generation unit 202 performs inference processing using an AI model by receiving, as inputs, the recorded image 211 and the target audio information 213 input in step S402, and generates the caption 214 of the recorded image 211.

According to the above-described first embodiment, it is possible to generate an accurate caption by using the target audio information 213 for a period of a predetermined number of frames before and after the recorded image 211 is shot, in addition to the recorded image 211.

### Second Embodiment

A second embodiment will be described next with reference to FIGS. 5 to 8.

In the first embodiment, when the image capture apparatus 100 is in the image shooting mode, audio information is always output from the audio input unit109. However, the second embodiment will describe an example of controlling the timing when the audio input unit109 acquires audio information.

The hardware configuration of an image capture apparatus 100 according to the second embodiment is the same as that shown in FIG. 1 of the first embodiment. The difference from the first embodiment will mainly be described below.

FIG. 5 is a block diagram exemplifying the functional configuration of the image capture apparatus 100 according to the second embodiment.

The image capture apparatus 100 is formed by adding a determination unit 503 to the configuration shown in FIG. 2 of the first embodiment.

The determination unit 503 receives state information 501 such as a non-recorded image, priority subject information, gaze sensor information, and shooting button information from a CPU 102, and outputs determination information 511 as a determination result of the state information 501 to the audio information control unit 201. The determination unit 503 outputs, to the audio input unit109, control information 521 for switching the audio input unit109 to an ON state of outputting audio information or an OFF state of outputting no audio information, and controls the timing of acquiring audio information 212.

The audio information control unit 201 selects the audio information 212 for a predetermined period based on the determination information 511, and outputs selected target audio information 213 to a caption generation unit 202. The caption generation unit 202 inputs the target audio information 213 output from the audio information control unit 201.

The caption generation unit 202 performs inference processing using an AI model by receiving a recorded image 211 and the target audio information 213 as inputs, and generates a caption 214 of the recorded image 211.

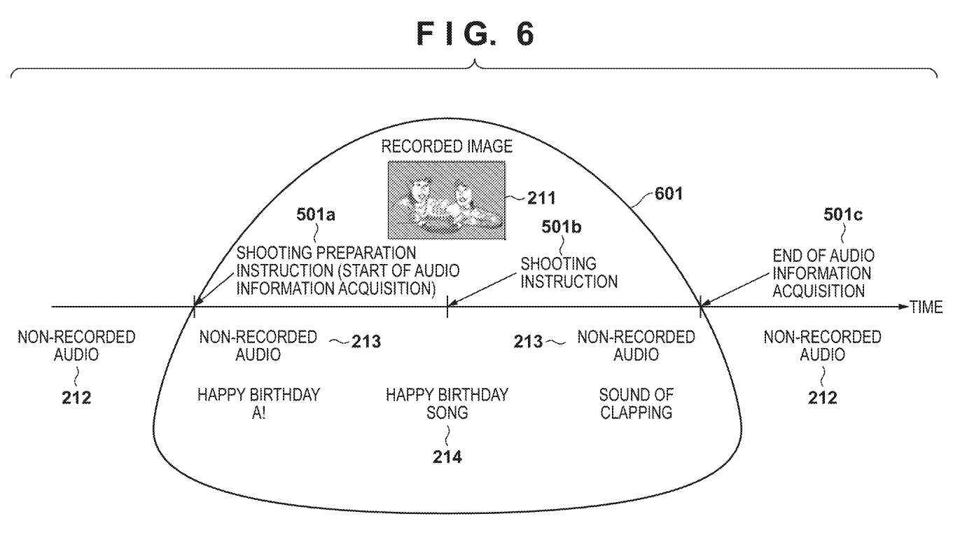

FIG. 6 exemplifies the recorded image 211, the audio information 212, the target audio information 213, the state information 501, and the caption 214 in caption generation processing according to the second embodiment.

In the example shown in FIG. 6, time elapses from left to right in FIG. 6, and the image capture apparatus 100 acquires one recorded image 211 in accordance with a shooting instruction from the user.

In a case where a first shutter switch signal SW1 is ON, the determination unit 503 determines a shooting preparation state, outputs the determination information 511 to the audio information control unit 201, and outputs the control information 521 to the audio input unit109. The audio input unit109 starts to acquire audio information based on the control information 521.

The audio information control unit 201 outputs, as the target audio information 213, the audio information 212 for an audio acquisition period based on the determination information 511. The caption generation unit 202 inputs the target audio information 213 output from the audio information control unit 201. In the example shown in FIG. 6, a period (a period from the shooting preparation state to a predetermined timing after a shooting state is set) surrounded by a solid line 601 is the audio acquisition period.

### Control Processing

FIG. 7 is a flowchart exemplifying the caption generation processing according to the second embodiment.

In step S701, the determination unit 503 determines whether audio acquisition start condition information 501a for determining an audio acquisition start timing is acquired from the CPU 102. When it is determined that the information is acquired, the process advances to step S702. When it is determined that no information is acquired, the processing is continued. In this embodiment, the audio acquisition start condition information 501a is information indicating that the first shutter switch signal SW1 is ON.

In step S702, when the determination unit 503 determines the audio acquisition start timing, the CPU 102 outputs the control information 521 for instructing the audio input unit109 to start audio acquisition, and the audio input unit109 starts audio acquisition.

In step S703, the determination unit 503 determines whether shooting start condition information 501b for determining a shooting start timing is acquired from the CPU 102. When it is determined that the information is acquired, the process advances to step S704. When it is determined that no information is acquired, the processing is continued. In this embodiment, the shooting start condition information 501b is information indicating that a second shutter switch signal SW2 is ON. Note that when, after the first shutter switch signal SW1 is turned on, the second shutter switch signal SW2 is not turned on and the first shutter switch signal SW1 is turned off, the process returns to step S701.

In step S704, it is determined whether the CPU 102 acquires audio acquisition end condition information 501c for determining an audio acquisition end timing. When it is determined that the information is acquired, the process advances to step S705. When it is determined that no information is acquired, the processing is continued. In this embodiment, the audio acquisition end condition information 501c is information indicating that a predetermined period has elapsed since the second shutter switch signal SW2 is turned on.

In step S705, the CPU 102 outputs the recorded image 211 to the caption generation unit 202. The audio information control unit 201 outputs, to the caption generation unit 202, as the target audio information 213, the audio information 212 acquired by the audio input unit109 for a period from the audio acquisition start timing to the audio acquisition end timing. The caption generation unit 202 inputs the target audio information 213 output from the audio information control unit 201.

In step S706, the caption generation unit 202 performs inference processing using an AI model by receiving, as inputs, the recorded image 211 and the target audio information 213 input in step S705, and generates the caption 214 of the recorded image 211.

The second embodiment has described an example in which the state information 501 acquired by the determination unit 503 is shutter button operation information. However, gaze information of a photographer or subject information can be used as the state information 501. In a case where gaze information of a photographer is used as the state information 501, the determination unit 503 calculates the degree of gaze of the photographer, and controls to start audio acquisition when the degree of gaze exceeds a threshold. More simply, when the photographer looks into a finder, audio acquisition may start. As the timing of ending audio acquisition, for example, the timing when the degree of gaze becomes equal to or lower than the threshold, the timing when the photographer moves away from the finder, or the like can appropriately be set. In this case, the audio information control unit 201 can output the audio information 212 of the photographer as the target audio information 213 to the caption generation unit 202.

In a case where subject information is used as the state information 501, the determination unit 503 determines whether a subject that is set as an AF target when the first shutter switch signal SW1 is turned on is a priority subject registered in advance in the image capture apparatus 100. When the subject is a priority subject, it may be controlled to start audio acquisition. In this case, the audio information control unit 201 can output the audio information 212 of the priority subject as the target audio information 213 to the caption generation unit 202.

Furthermore, in this embodiment, operation information of a shutter button, gaze information of a photographer, and subject information may be used in combination as the state information 501, or other information may be used. In addition, the predetermined period may be changed based on a shooting scene.

According to the above-described second embodiment, it is possible to generate an accurate caption using more appropriate target audio information by controlling the timing when the audio input unit109 acquires audio information in accordance with the state information 501 of the image capture apparatus 100.

### Third Embodiment

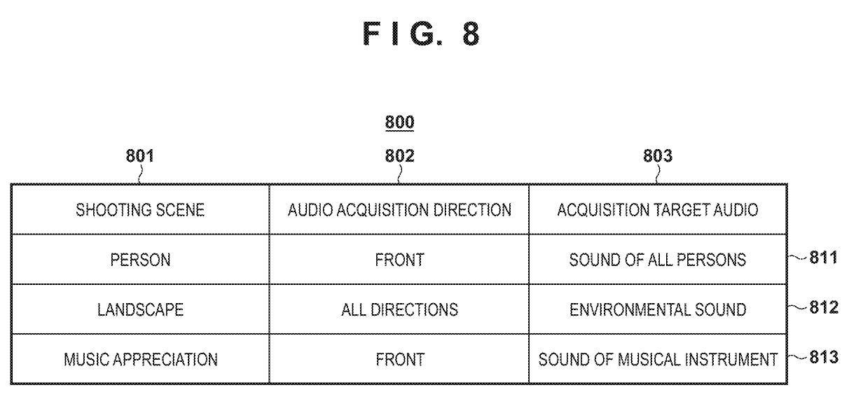

A third embodiment will be described next with reference to FIG. 8.

The third embodiment will describe an example of generating an appropriate caption by changing target audio information 213 in accordance with a shooting scene.

The hardware configuration of an image capture apparatus 100 according to the third embodiment is the same as that shown in FIG. 1 of the first embodiment. The functional configuration of the image capture apparatus 100 is the same as that shown in FIG. 2 of the second embodiment. The difference from the first and second embodiments will mainly be described below.

In the third embodiment, a lookup table (LUT) 800 exemplified in FIG. 8 is stored in a ROM 103, and a determination unit 503 determines the target audio information 213 with reference to the LUT 800 in accordance with a shooting scene of the image capture apparatus 100.

The LUT 800 registers a shooting scene 801 of the image capture apparatus 100, an audio acquisition direction 802 for each shooting scene 801, and an acquisition target audio 803 for each shooting scene 801.

The acquisition target audio 803 indicates signal processing to be performed with respect to the audio acquisition direction 802 to generate the target audio information 213. In this embodiment, for the sake of easy understanding, the acquisition target audio 803 is audio to be acquired but is actually recorded as information indicating filter processing to be performed.

In the example shown in FIG. 8, a person 811, a landscape 812, and a music appreciation 813 are exemplified as the shooting scenes 801. The shooting scene may be selected by the user, or may automatically be determined by the image capture apparatus 100 from a recorded image.

This embodiment will describe a case where it is possible to control audio information to be acquired when, for example, the audio input unit109 includes three or more microphones or a directional microphone.

In a case where the shooting scene 801 is the person 811, the audio acquisition direction 802 is set to the front of the image capture apparatus 100, and sound in front of the image capture apparatus 100 is acquired. This means that sound in the direction of a shooting target is mainly acquired. To acquire only the voice of the person, the acquired audio undergoes a noise canceling operation by the signal processing of the audio information control unit 201, thereby generating the target audio information 213. The signal processing according to this embodiment may be rule-based processing using an LUT or the like or processing using an AI model. By changing the target audio information 213 to be output to the caption generation unit 202 in accordance with the shooting scene, it is possible to generate a more accurate caption.

In a case where the shooting scene 801 is the landscape 812, the audio acquisition direction 802 is set to the front, rear, right, and left of the image capture apparatus 100 without giving directivity, and all sound around the image capture apparatus 100 is acquired. The signal processing by the audio information control unit 201 does not perform a noise canceling operation as much as that for the shooting scene 801 of the person 811 to generate the target audio information 213, and outputs it as environmental sound to the caption generation unit 202. In this manner, it is possible to generate a caption added with information indicating that, for example, it is windy.

In a case where the shooting scene 801 is the music appreciation 813, the audio acquisition direction 802 is set to the front of the image capture apparatus 100 and sound in front of the image capture apparatus 100 is acquired, similar to the case where the shooting scene 801 is the person 811. The signal processing by the audio information control unit 201 changes a filter characteristics and the like, as in the case where the shooting scene 801 is the person 811 so as to acquire the sound of a musical instrument. The caption generation unit 202 can add additional information such as a song title to a caption.

This embodiment has described a case where it is possible to control audio to be acquired when, for example, the audio input unit109 includes three or more microphones or a directional microphone. The present disclosure is not limited to this, and may be implemented using a stereo microphone, a monaural microphone, or the like. In this case, preferable filter processing is performed on acquired audio with reference to the information of the acquisition target audio 803, instead of the information of the audio acquisition direction 802 of the LUT 800, thereby generating the target audio information 213.

This embodiment has exemplified the person 811, the landscape 812, and the music appreciation 813 as the shooting scenes 801. However, the shooting scene is not limited to these, and may include, for example, animals and sports.

In addition, the determination unit 503 may function as an audio separation unit that separates audio information acquired by the audio input unit109 for each sound type, and the audio information control unit 201 may change, in accordance with the sound type, the degree of importance of the audio information to be output as the target audio information 213 to the caption generation unit 202. In this case, for example, when the sound type indicates the sound of a priority subject as the target of AF processing or the sound of a photographer, it is considered to set the degree of importance higher than those of other sound types.

According to the above-described third embodiment, by changing target audio information in accordance with a shooting scene, it is possible to generate an accurate caption according to the shooting scene.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-035856, filed March 6, 2025 which is hereby incorporated by reference herein in its entirety.

What is claimed is:

1. An image capture apparatus which captures an image and stores the image as a recorded image, comprising:
an audio acquisition unit that acquires audio information at the time of shooting the recorded image;
a caption generation unit that generates a caption of the recorded image based on the recorded image and the audio information; and
a control unit that controls the audio information to be output to the caption generation unit.

2. The apparatus according to claim 1, further comprising a storage unit that stores the recorded image,
wherein the audio information is non-recorded audio information that is not stored in the storage unit.

3. The apparatus according to claim 2, further comprising an input unit that accepts a user operation,
wherein the control unit outputs, to the caption generation unit, target audio information, of the audio information acquired by the audio acquisition unit, for a predetermined period before and after the input unit accepts a shooting instruction.

4. The apparatus according to claim 3, wherein the predetermined period is a period of a predetermined number of frames before and after the recorded image.

5. The apparatus according to claim 3, further comprising a determination unit that determines state information of the image capture apparatus,
wherein the determination unit controls the acquisition of the audio information by the audio acquisition unit based on a determination result of the state information, and
the control unit outputs, as the target audio information, the audio information acquired by the audio acquisition unit to the caption generation unit based on the determination result of the state information.

6. The apparatus according to claim 5, wherein
the state information includes a shooting preparation state and a shooting state, and
the predetermined period includes a period from the shooting preparation state to a predetermined timing after the shooting state is set.

7. The apparatus according to claim 5, wherein
the state information includes gaze information of a photographer, and
the determination unit controls the audio acquisition unit to start audio acquisition at the time at which a degree of gaze of the photographer exceeds a threshold.

8. The apparatus according to claim 5, wherein
the state information includes gaze information of a photographer, and
the determination unit controls the audio acquisition unit to start audio acquisition at the time at which the photographer looks into a finder and end the audio acquisition at the time at which the photographer moves away from the finder.

9. The apparatus according to claim 5, wherein
the state information includes subject information, and
the determination unit controls the audio acquisition unit to start audio acquisition in a case where a subject serving as a target of auto focus processing is a priority subject registered in advance.

10. The apparatus according to claim 3, further comprising a determination unit that determines a shooting scene,
wherein the determination unit changes the predetermined period in accordance with the shooting scene.

11. The apparatus according to claim 2, further comprising:
a plurality of audio acquisition units; and
a determination unit that changes audio information to be used by the caption generation unit from audio information acquired by the plurality of audio acquisition units.

12. The apparatus according to claim 11, further comprising a table in which a direction of the audio information to be acquired by the plurality of audio acquisition units and the audio information to be acquired are determined for each shooting scene,
wherein the determination unit determines, in accordance with the shooting scene, the direction of the audio information to be acquired by the plurality of audio acquisition units and the audio information to be acquired with reference to the table.

13. The apparatus according to claim 11, wherein
the shooting scene includes a person, a landscape, and a music appreciation.

14. The apparatus according to claim 13, wherein
in a case where the shooting scene is a person, the direction of the audio information to be acquired by the plurality of audio acquisition units indicates a front of the image capture apparatus, and the audio information to be acquired is audio information of only a person.

15. The apparatus according to claim 13, wherein in a case where the shooting scene is a landscape, the direction of the audio information to be acquired by the plurality of audio acquisition units indicates all directions of the image capture apparatus, and the audio information to be acquired is audio information of environmental sound.

16. The apparatus according to claim 13, wherein in a case where the shooting scene is a music appreciation, the direction of the audio information to be acquired by the plurality of audio acquisition units indicates a front of the image capture apparatus, and the audio information to be acquired is audio information of a musical instrument.

17. The apparatus according to claim 1, further comprising an audio separation unit that separates the audio information acquired by the audio acquisition unit for each sound type,
wherein the control unit changes, in accordance with the sound type, a degree of importance of the audio information to be output to the caption generation unit.

18. The apparatus according to claim 17, wherein in a case where the sound type indicates sound of a subject serving as a target of auto focus processing, a degree of importance of the type of the sound of the subject is set higher than those of other sound types.

19. The apparatus according to claim 17, wherein in a case where the sound type indicates sound of a photographer, a degree of importance of the type of the sound of the photographer is set higher than those of other sound types.

20. The apparatus according to claim 1, wherein the caption generation unit performs inference processing using an AI model by receiving the recorded image and the audio information as inputs, and generates a caption of the recorded image.

21. A control method of an image capture apparatus which captures an image and stores the image as a recorded image, comprising:
acquiring audio information at the time of shooting the recorded image; and
controlling the audio information to be used to generate a caption at the time of generating the caption of the recorded image based on the recorded image and the audio information.

22. A non-transitory computer-readable storage medium storing a program for causing a computer to function as an image capture apparatus which captures an image and stores the image as a recorded image, comprising:
an audio acquisition unit that acquires audio information at the time of shooting the recorded image;
a caption generation unit that generates a caption of the recorded image based on the recorded image and the audio information; and
a control unit that controls the audio information to be output to the caption generation unit.
